(19) United States
(12) Patent Application Publication
(10) Pub. No.: US 2025/0340264 A1
(43) Pub. Date: Nov. 6, 2025

(54) INTEGRATED BICYCLE FRAME WITH MULTI-FUNCTIONAL TOUCH SCREEN SYSTEM

(71) Applicant: Joseph P Vulk, JR., Issaquah, WA (US)

(72) Inventor: Joseph P Vulk, JR., Issaquah, WA (US)

(21) Appl. No.: 18/655,421

(22) Filed: May 6, 2024

(51) Int. Cl. B62J 50/22; B62J 43/30; B62J 45/10; B62K 3/02; G01C 21/36; H04M 1/72409

(52) U.S. Cl. CPC B62J 50/22; B62J 43/30; B62J 45/10; G01C 21/3667; B62K 3/02; H04M 1/72409

(57) ABSTRACT

The present disclosure relates to an integrated bicycle frame with a multi-functional touch screen system, which involves a multidisciplinary approach, bringing together expertise from mechanical engineering, electrical engineering, software development, and human-computer interaction to create an innovative and seamless solution for cyclists. The bicycle frame comprising a touch screen computer integrated directly into the frame, wherein the touch screen computer features a rectangular and flat screen form factor to achieve a sleek and cohesive design for cyclists. The bicycle frame, wherein the touch screen computer further comprises a curved surface that wraps around the tubular frame of the bicycle that conforms to the shape of the bicycle's tubular frame and the curvature of the touch screen to allow seamless blend with the contours of the frame, enhancing the aesthetics of the bicycle while maintaining functionality.

### TECHNICAL FIELD

The present disclosure relates to an integrated bicycle frame with a multi-functional touch screen system, which requires a multidisciplinary approach, bringing together expertise from mechanical engineering, electrical engineering, software development, and human-computer interaction to create an innovative and seamless solution for cyclists.

Also, the technical field of the integrated bicycle frame with a multi-functional touch screen system encompasses various disciplines, including mechanical engineering, electrical engineering, software development, and human-computer interaction.

Mechanical Engineering: This aspect involves the design and fabrication of the bicycle frame itself. Engineers in this field focus on optimizing the structural integrity, weight, and aerodynamics of the frame while accommodating the integration of the touch screen system. Considerations such as frame material, geometry, and mounting points for the touch screen are crucial to ensure durability, stability, and compatibility with different bicycle designs.

Electrical Engineering: The touch screen system relies on electrical components for its functionality. Electrical engineers are responsible for designing the circuitry, power management systems, and connectivity features of the touch screen computer. This includes integrating components such as the charging port, battery, data port, and camera/s into the bicycle frame while ensuring compatibility, efficiency, and safety.

Software Development: The touch screen system requires software to operate its various functionalities, including navigation, communication, and multimedia playback. Software developers create user interfaces, applications, and operating systems tailored for the integrated touch screen computer. They also implement features such as GPS navigation, map displays, cellular connectivity, and camera functionalities to provide a seamless user experience for cyclists.

Human-Computer Interaction (HCl): HCl specialists focus on optimizing the interaction between cyclists and the touch screen system. They design intuitive user interfaces, ergonomic layouts, and responsive touch controls to enhance usability and safety while riding. Considerations such as screen visibility, touch sensitivity, and user feedback mechanisms are essential to ensure that cyclists can access and control the system effectively without distractions.

### BACKGROUND

Cycling has long been recognized as an eco-friendly, health-promoting, and enjoyable mode of transportation and recreation. Over the years, cycling has evolved from its humble beginnings as a simple means of transportation to a multifaceted activity embraced by enthusiasts worldwide. Cycling has always been more than just a mode of transportation or a form of exercise; it's a way of life for millions of people around the globe. From daily commuters navigating busy city streets to weekend adventurers exploring scenic countryside routes, cyclists embody a diverse community united by a shared passion for two-wheeled travel. With advancements in technology, cyclists are increasingly looking for ways to enhance their riding experience, improve safety, and stay connected while on the road.

Throughout history, bicycles have undergone significant evolution, transitioning from simple wooden contraptions to sophisticated machines engineered for performance, comfort, and style. Innovations in frame materials, drivetrain systems, and aerodynamics have propelled the bicycle into the realm of high-tech engineering while preserving its fundamental principles of simplicity and efficiency.

Traditional bicycles have undergone significant technological advancements, with improvements in materials, design, and components aimed at optimizing performance and comfort. However, the integration of electronic devices, such as GPS navigation systems and smartphones, into the cycling experience has presented new opportunities and challenges. Yet, as the world becomes increasingly interconnected through technology, cyclists are seeking ways to integrate electronic devices seamlessly into their riding experience. From GPS navigation systems to fitness trackers and communication devices, cyclists rely on a myriad of gadgets to enhance their rides and stay connected with the world around them.

In recent years, cyclists have turned to various electronic devices to enhance their riding experience. GPS navigation systems have become essential tools for cyclists seeking to explore new routes and navigate unfamiliar terrain. Similarly, smartphones have become ubiquitous accessories for cyclists, providing access to communication, navigation, and entertainment apps on the go.

Also, the integration of these electronic devices into the cycling experience has presented challenges. Mounting devices onto handlebars or stems often leads to cluttered setups, compromised aerodynamics, and potential safety hazards. Moreover, interacting with devices like smartphones while riding can be cumbersome and unsafe, requiring cyclists to divert their attention from the road ahead.

However, the mounting of these devices onto bicycle handlebars or stems often leads to cluttered setups, compromised aerodynamics, and potential safety hazards. Moreover, the use of smartphones while cycling can be cumbersome and unsafe, as it requires cyclists to take their eyes off the road and hands off the handlebars to interact with the device.

Recognizing these challenges, innovators in the field of cycling technology have sought to develop integrated solutions that seamlessly incorporate essential electronic functionalities into the bicycle itself. By integrating electronic devices directly into the bicycle frame, these solutions aim to streamline the riding experience, enhance safety, and improve aesthetics.

One significant advancement in this regard is the integration of touch screen technology into bicycle frames. Touch screens offer an intuitive interface for accessing navigation, communication, and entertainment features while riding. By embedding touch screen computers directly into the bicycle frame, cyclists can enjoy the benefits of electronic devices without the drawbacks of cumbersome mounts or distractions.

The development of an integrated bicycle frame with a multi-functional touch screen system builds upon these advancements, offering cyclists a comprehensive platform for communication, navigation, and entertainment seamlessly integrated into the bicycle frame. By combining essential characteristics of touch screen computers, navigation systems, and cellular phones into a unified system, this innovation represents a new paradigm in cycling technology, promising to revolutionize how cyclists interact with their bikes and the world around them.

Challenges with Conventional Mounting Solutions: While electronic devices offer numerous benefits to cyclists, integrating them into the riding experience presents challenges. Traditional mounting solutions, such as handlebar mounts or stem mounts, can detract from the aesthetics of the bicycle and compromise aerodynamic efficiency. Additionally, these mounts may obstruct the rider's view of the road or impede access to essential controls. Furthermore, interacting with devices mounted on the handlebars or stem can be cumbersome and distracting, posing safety risks to both the cyclist and other road users.

Rise of Integrated Solutions: Innovators within the cycling community have begun exploring integrated solutions that seamlessly incorporate electronic devices into the bicycle itself. By embedding electronic components directly into the bicycle frame, these solutions aim to streamline the riding experience, improve safety, and enhance aesthetics. Integrated solutions offer cyclists a cleaner, more cohesive design that preserves the sleek lines and aerodynamic profile of the bicycle while providing easy access to essential features and functionalities.

Promise of Touch Screen Technology: Touch screen technology has emerged as a promising solution for integrating electronic devices into the cycling experience. Touch screens offer an intuitive interface that allows cyclists to interact with their devices using familiar gestures such as tapping, swiping, and pinching. By embedding touch screen computers directly into the bicycle frame, cyclists can access navigation, communication, and entertainment features without the need for external mounts or accessories. This seamless integration enhances the overall aesthetics of the bicycle while minimizing distractions and improving safety.

The Vision for Integrated Bicycle frame with a Multi-Functional Touch Screen System: The integrated bicycle frame with a multi-functional touch screen system represents the next evolution in cycling technology. This innovative system combines essential characteristics of touch screen computers, navigation systems, and cellular phones into a unified platform seamlessly integrated into the bicycle frame. By providing cyclists with a comprehensive interface for communication, navigation, and entertainment, this system promises to revolutionize the cycling experience, offering unparalleled convenience, safety, and enjoyment.

The integrated bicycle frame with a multi-functional touch screen system builds upon the rich history of cycling technology while embracing the latest advancements in electronics and user interface design. By addressing the challenges posed by conventional mounting solutions and leveraging the intuitive nature of touch screen technology, this innovative system aims to redefine the cycling experience, empowering cyclists to explore new routes, stay connected, and enjoy every ride to the fullest.

### OBJECTS

The principal object of the present disclosure is to revolutionize the cycling experience by seamlessly integrating essential electronic functionalities directly into the bicycle frame.

Specifically, the objects of the integrated system include: Streamlined Riding Experience: By embedding touch screen computers directly into the bicycle frame, the system eliminates the need for external mounts or accessories, resulting in a cleaner, more cohesive design. Cyclists can access navigation, communication, and entertainment features seamlessly while riding, without the distractions or safety risks associated with traditional mounting solutions.

Enhanced Safety: The integrated touch screen system minimizes distractions by providing a centralized interface for accessing essential features without the need to divert attention from the road. With intuitive touch controls and ergonomic design, cyclists can interact with the system safely and efficiently, reducing the likelihood of accidents or collisions.

Improved Aesthetics: Integrating electronic devices into the bicycle frame preserves the sleek lines and aerodynamic profile of the bike, enhancing its overall aesthetics. By seamlessly blending technology with traditional bicycle design, the integrated system offers a visually appealing and harmonious aesthetic that appeals to cyclists who value both form and function.

Convenience and Accessibility: With the touch screen system integrated directly into the bicycle frame, essential features and functionalities are easily accessible to cyclists at all times. Whether navigating unfamiliar terrain, communicating with fellow riders, or capturing memorable moments, cyclists can interact with the system effortlessly using familiar gestures such as tapping, swiping, and pinching.

Versatility and Customization: The integrated system offers a versatile platform for communication, navigation, and entertainment, with customizable features and functionalities to suit individual preferences and riding styles. Cyclists can personalize their experience by selecting preferred apps, display layouts, and settings, ensuring a tailored experience that meets their unique needs.

The object of the integrated bicycle frame with a multi-functional touch screen system is to redefine the cycling experience by combining innovation, convenience, and safety in a single, elegant solution. By seamlessly integrating electronic functionalities directly into the bicycle frame, this system aims to empower cyclists to explore new routes, stay connected, and enjoy every ride to the fullest.

### SUMMARY

A bicycle frame comprising a touch screen computer integrated directly into the frame, wherein the touch screen computer features a rectangular and flat screen form factor to achieve a sleek and cohesive design for a cyclists. The bicycle frame, wherein the touch screen computer further comprises a curved surface that wraps around the tubular frame of the bicycle that conforms to the shape of the bicycle's tubular frame and the curvature of the touch screen to allow seamless blend with the contours of the frame, enhancing the aesthetics of the bicycle while maintaining functionality. The bicycle frame, wherein the curved surface of the touch screen computer adapts to the shape of the frame, providing compatibility with various frame geometries to conform different frame shapes and sizes ensuring that the integrated system be seamlessly incorporated intowide range of bicycle designs. The bicycle frame, wherein the touch screen computer includes all necessary characteristics of a touch screen device, including a charging port, a battery, a data port, and camera for multimedia functionalities enabling the cyclists to utilize the touch screen computer for various multimedia and communication purposes while riding. The bicycle frame, further comprising a navigation system integrated into the touch screen computer, wherein the navigation system provided map displaying and global positioning system (GPS) functions associated with the navigation tools. The bicycle frame, wherein the navigation system provides turn-by-turn directions, real-time positioning, and route customization features for the cyclists to enhance user experience, allowing cyclists to plan and navigate their rides with precision. The bicycle frame, incorporates all functions and tools associated with a cellular phone into the touch screen computer, comprising a Subscriber Identity Module (SIM) card port, cellular connectivity, messaging applications, and access to cellular network services, thereby making comprehensive communication and connectivity hub for cyclists. The bicycle frame, wherein the cell phone functionalities enable cyclists to make and receive calls, send and receive messages, access internet services, and stream media content while riding, to enhance convenience and connectivity for cyclists, allowing them to stay connected while on the move. The bicycle frame, wherein the integration of electronic functionalities into the frame enhances convenience, safety, and aesthetics for cyclists, by consolidating features such as navigation, multimedia, and communication into a single integrated system, cyclists experience enhanced convenience and accessibility while riding.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the drawings, in which:

FIG. 1 is an example diagram illustrating a touch screen display with a rectangular and flat screen display for user interaction with the electronic device configured to the bike frame, according to embodiments as disclosed herein.

FIG. 2 is an example diagram illustrating the curved surface of the display which can be wrapped around the tubular frame of the bike for easy access to the user, according to embodiments as disclosed herein;

FIG. 3 is an example diagram illustrating the non-linear surface of the touch-screen display, which can be configured to any desired shape of the frame based on the user, according to embodiments as disclosed herein;

FIG. 4 is an example diagram illustrating the usage of mobile or other touch-screen functionality on the tubular frame of the bike with additional screens showing a rider's personal image, corporate logo, advertisement or other imagery and touch-screen functionality, according to embodiments as disclosed herein; and

FIG. 5 is an example diagram illustrating the non-linear surface of a touch-screen display integral to and following the shape of the frame. In this embodiment, the display is imagined to use recent flexible screen technology and is integral to the bicycle frame.

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

In the following description, for the purposes of explanation, numerous specific details are set forth in order to provide a thorough understanding of implementations of the present technology. It will be apparent, however, to one skilled in the art that implementations of the present technology can be practiced without some of these specific details.

Described in detail below is the concept of all-inclusive co-working space based on a membership model, which provides a collaborative and inspiring work environment to professionals and independent workers like freelancers, entrepreneurs, students, and others.

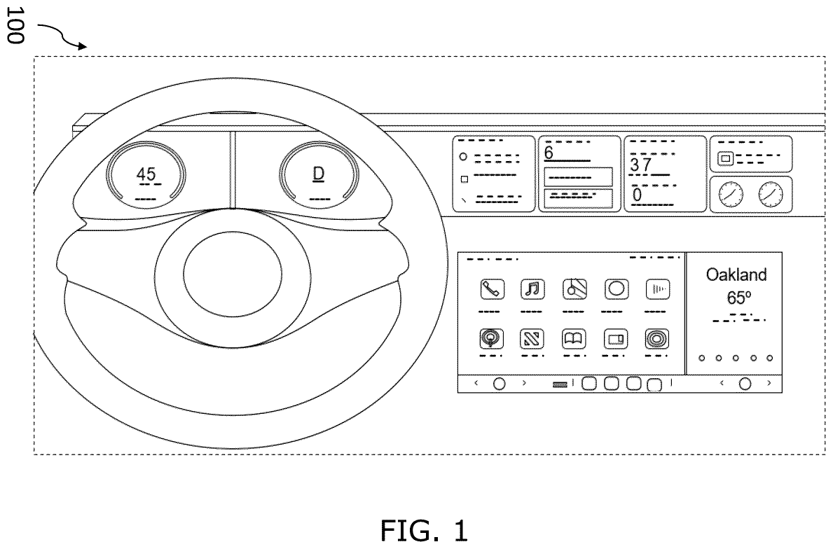

FIG. 1 is an example diagram illustrating a touch screen display with a rectangular and flat screen display for the user interaction with the electronic device configured to the bike frame, according to embodiments as disclosed herein. FIG. 1 is an example diagram illustrating a touch screen display with a rectangular and flat screen display for the user interaction with the electronic device configured to the bike frame, according to embodiments as disclosed herein. As illustrated in FIG. 1, the touch screen display 100 can be integrated with various components which can be embedded within the bicycle frame.

As illustrated in FIG. 1, the touch screen computer is a central component of the integrated system, seamlessly embedded within the bicycle frame. It serves as the primary interface for accessing various functionalities while riding. As illustrated in FIG. 1, the form factor, in which the touch screen computer features a rectangular and flat screen form factor, reminiscent of modern touchscreen devices such as tablets and smartphones. This design allows for intuitive interaction, with familiar gestures like tapping, swiping, and pinching.

As illustrated in FIG. 1, the essential characteristics in which the touch screen computer encompasses all essential features of a modern touchscreen device. This includes a charging port for replenishing the battery, a built-in battery for portable operation, a data port for connectivity, and camera(s) for capturing images and videos. These features empower cyclists with communication, entertainment, and navigation capabilities while on the move.

Also as illustrated in FIG. 1, the navigation system can be integrated to the touch system 100 of the bike frame. In addition to its role as a touch screen computer, the integrated system incorporates a dedicated navigation screen seamlessly integrated into the bike frame. Also, as illustrated in FIG. 1, the navigation screen provides cyclists with clear and detailed map displays, showing their current location, planned route, and points of interest along the way. Cyclists can customize their routes based on preferences such as distance, terrain, and scenic routes.

In addition, FIG. 1 displays the GPS functions, in which the navigation system harnesses the power of GPS technology to offer precise location tracking, real-time positioning, and accurate navigation guidance. Cyclists receive turn-by-turn directions, distance to destination, estimated time of arrival, and alerts for upcoming turns or waypoints.

Additionally, the mobile function can be integrated, beyond serving as a touch screen computer and navigation system, the integrated solution integrates all functionalities typically associated with a modern cell phone directly into the bicycle frame. The screen integration which can be performed in which the cell phone screen is seamlessly integrated into the bike frame, eliminating the need for separate devices or mounts. Cyclists have immediate access to cellular network services and smartphone functionalities without compromising the bike's design or aerodynamics.

The essential features of the touch screen display 100 of FIG. 1, in which the cell phone functionality encompasses features such as a SIM card port for cellular connectivity, a charging port for powering the device, a built-in battery for extended use, a data port for connectivity to external devices, and camera(s) for capturing photos and videos. Additionally, cyclists can access a wide array of apps commonly available on smartphones, including messaging, social media, fitness tracking, and navigation applications.

Further, the connectivity feature of the mobile can be integrated to the bicycle frame. Therefore, by integrating cell phone functionality into the bicycle frame, cyclists can stay connected while on the move. They can make and receive calls, send and receive messages, access internet services, and stream media content without the need to carry a separate smartphone. This enhances safety, convenience, and peace of mind during rides, particularly in emergency situations.

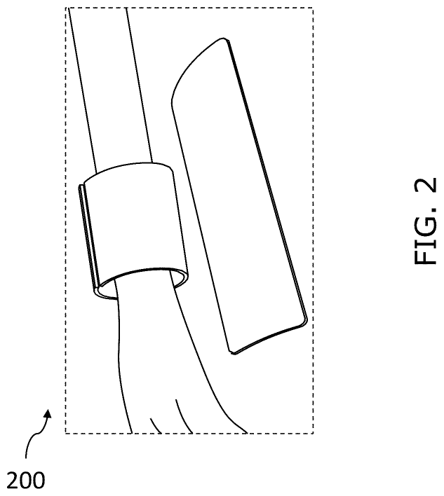

FIG. 2 is an example diagram illustrating the curved surface of the display which can be wrapped around the tubular frame of the bike for easy access to the user, according to embodiments as disclosed herein. As illustrated in FIG. 2, the curved surface 200 of the display has been designed to harmonize with the contours of the bicycle frame, the touch screen boasts a curved surface that wraps around the tubular structure. This curvature ensures a sleek and integrated appearance, minimizing any visual disruptions to the frame's aesthetics.

As illustrated in FIG. 2, the non-linear surface, the touch screen's surface of the bicycle is non-linear, meaning it can adapt to the shape of the frame without compromising functionality. This flexibility allows for seamless integration into frames of varying geometries, ensuring a snug fit and consistent user experience.

As illustrated in FIG. 2, the seamless integration of the touch screen with the curved surface 200 of the display provides navigation, and cell phone functionalities into the bicycle frame ensures a streamlined and cohesive user experience. Hence, the cyclists can have immediate access to essential features and functionalities without the need for additional devices or mounts, simplifying their riding experience and making it more enjoyable. This eliminates the need to carry separate devices or rely on cumbersome mounts, streamlining the riding experience and allowing cyclists to focus on the road ahead.

As illustrated in FIG. 2, the curved surface 200 provides improved safety in which the centralized control and minimized distractions, cyclists can stay focused on the road ahead, reducing the risk of accidents or mishaps. Also, the versatile design provides a adaptable nature of the integrated system allowing it to accommodate various frame shapes and sizes, catering to the diverse needs and preferences of the cyclists. As safety is a paramount concern for cyclists, especially when navigating busy roads or challenging terrain. The integrated bicycle frame with a multi-functional touch screen system in the curved surface 200 enhances safety by minimizing distractions and reducing the need for cyclists to take their hands off the handlebars or eyes off the road. With centralized control and intuitive interfaces, cyclists can access navigation directions, communicate with others, and capture moments without compromising their attention or reaction time.

The curved surface 200 provides versatility in design providing key advantage of this system is its versatility in design, allowing it to accommodate various frame shapes, sizes, and configurations. The touch screen computer's curved and non-linear surface adapts to the contours of the bicycle frame, ensuring a snug fit and consistent user experience regardless of the frame geometry. This versatility enables manufacturers to offer a wide range of bicycle models equipped with the integrated system, catering to the diverse needs and preferences of cyclists.

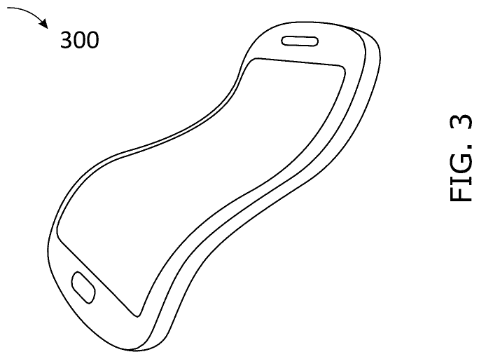

FIG. 3 is an example diagram illustrating the non-linear surface of the touch-screen display which can be configured to any desired shape 300 of the frame based on the user, according to embodiments as disclosed herein. The versatility of the touch screen in the context of the integrated bicycle frame with a multi-functional touch screen system refers to the system's ability to adapt to various frame shapes, sizes, and configurations while maintaining consistent functionality and user experience. As illustrated in FIG. 3, the adaptability of the touch screen to the bicycle frame depends on the frame shapes.

The bicycle frames come in a wide range of shapes and geometries, including traditional diamond frames, step-through frames, and compact frames, among others. The integrated touch screen system's versatility allows it to seamlessly integrate into frames of different shapes and sizes. The touch screen's curved surface conforms to the contours of the bicycle frame, ensuring a snug fit and enhancing the overall aesthetics of the bike. Whether the frame is angular, curved, or unconventional in shape, the touch screen adapts to provide a cohesive and integrated appearance.

Further, the touch screen's non-linear surface design is the key aspect to the disclosed invention. The touch screen's non-linear surface design is a key aspect of its versatility. Unlike traditional flat screens, the touch screen's surface is flexible and adaptable, allowing it to conform to the curvature of the bicycle frame. This non-linear surface design ensures that the touch screen maintains full functionality and responsiveness regardless of the frame's shape or geometry. Cyclists can interact with the touch screen interface smoothly, accessing navigation, communication, and entertainment features without any compromises in usability.

Therefore, it provides consistent user experience to the cyclists. Despite the varying shapes and sizes of bicycle frames, the integrated touch screen system offers a consistent user experience across different models. Cyclists can expect the same level of functionality, responsiveness, and ease of use regardless of the frame they choose. Hence, the consistency in user experience enhances the system's appeal to a wide range of cyclists, from casual riders to enthusiasts and professionals. Whether riding a road bike, mountain bike, or urban commuter, cyclists can enjoy the benefits of the integrated touch screen system without sacrificing performance or convenience.

As illustrated in FIG. 3, the design flexibility of the touch screen can be provided by the manufacturers. The versatility of the integrated touch screen system also extends to manufacturers, offering them greater flexibility in designing and producing bicycles equipped with the system. Hence, the manufacturers can create custom frame designs without being constrained by the need to accommodate external devices or mounts for electronic components. This freedom allows for greater creativity and innovation in bicycle design, resulting in a diverse range of options for cyclists to choose from.

Also, the enhanced customization can be provided to the cyclists based on their requirements. Cyclists can benefit from the system's versatility through enhanced customization options. With the integrated touch screen system seamlessly integrated into the frame, cyclists can personalize their bikes according to their preferences and riding style. Whether seeking a sleek and minimalist design or a bold and eye-catching aesthetic, cyclists can choose frames that best suit their tastes while still enjoying the benefits of the integrated touch screen system.

As illustrated in FIG. 3, the integration of cell phone functionalities into the bicycle frame enhances connectivity for cyclists, allowing them to stay connected while on the move. With features such as SIM card support, cellular network connectivity, messaging apps, and internet access, cyclists can make and receive calls, send and receive messages, and access online services without the need for a separate smartphone. This connectivity enhances safety, convenience, and peace of mind during rides, particularly in emergency situations. Also, the touch screen with the desired shape 300 can provide streamlined riding experience to the users. Overall, the integrated bicycle frame with a multi-functional touch screen system offers a streamlined riding experience that enhances the enjoyment and utility of cycling. By consolidating essential electronic functionalities into the bicycle frame, this system simplifies the riding experience for cyclists, allowing them to focus on the journey and explore new routes with confidence and ease.

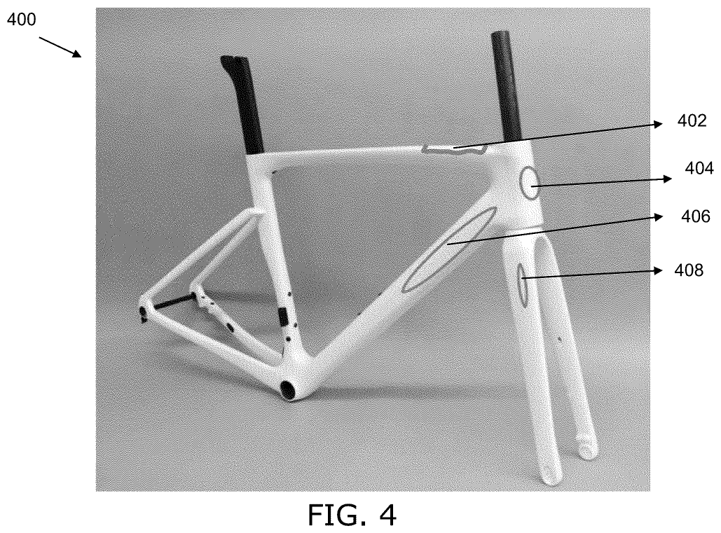

FIG. 4 is an example diagram illustrating the usage of mobile or any other devices on the tubular frame of the bike along with a rider personal image. As illustrated in FIG. 4, the integrated bicycle frame with a multi-functional touch screen system, which involves a multidisciplinary approach, bringing together expertise from mechanical engineering, electrical engineering, software development, and human-computer interaction to create an innovative and seamless solution for cyclists. The bicycle frame comprises a touch screen computer integrated directly into the frame, featuring a rectangular and flat screen form factor to achieve a sleek and cohesive design for cyclists. Additionally, the touch screen computer includes functionalities such as a cell phone, allowing cyclists to make and receive calls, send and receive messages, access internet services, and stream media content while riding, thereby enhancing convenience and connectivity.

Moreover, the touch screen computer is equipped with the capability to display a corporate logo or other images, enabling businesses to promote their brand or display relevant information to cyclists. Furthermore, the touch screen system allows riders to upload and display their personal images, adding a personalized touch to their biking experience. Lastly, the touch screen computer supports the display of a corporate logo, providing businesses with the opportunity to advertise their brand while enhancing the overall aesthetics of the bicycle frame. The bicycle frame further includes a curved surface that wraps around the tubular frame of the bicycle, conforming to the shape of the bicycle's tubular frame and the curvature of the touch screen to seamlessly blend with the contours of the frame, enhancing the aesthetics of the bicycle while maintaining functionality.

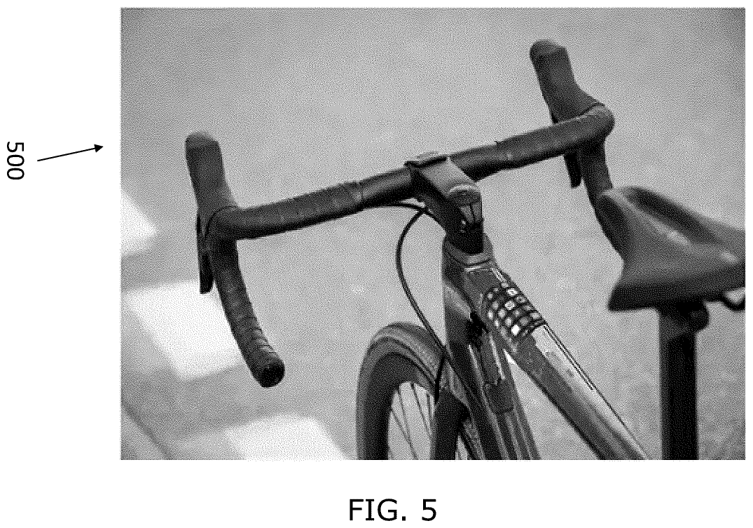

FIG. 5 is an example diagram illustrating the usage of a touch-screen computer which is integral to the bicycle frame and utilizes recent developments in flexible flat-screen technology allowing the screen to conform to the contours of the frame. As illustrated in FIG. 5, the integrated bicycle frame with a multi-functional touch screen system, involves a multidisciplinary approach, bringing together expertise from mechanism engineering, electrical engineering, software development, and human-computer interaction to create an innovative and seamless solution for cyclists. The bicycle frame comprises a touch screen computer integrated directly into the frame, featuring a non-linear screen form factor which conforms to the various and inconsistent curvatures of the bicycle frame, accommodating various frame surface geometries commonly used in the bicycle manufacturing industry. Additionally, the touch screen computer includes functionalities such as a cell phone, allowing cyclists to make and receive calls, send and receive messages, access internet services, and stream media content while riding, thereby enhancing convenience and connectivity. Additionally, but not visible in the image are common functionalities associated with cellular phones, such as a camera, charging port, battery and so forth.

1. A bicycle frame comprising a touch screen computer integrated directly into the frame, wherein the touch screen computer features a rectangular and flat screen form factor to achieve a sleek and cohesive design for a cyclist.

2. The bicycle frame of claim 1, wherein the touch screen computer further comprises a curved surface that wraps around the tubular frame of the bicycle, conforming to the shape of the bicycle's tubular frame and the curvature of the touch screen to allow seamless blending with the contours of the frame, enhancing the aesthetics of the bicycle while maintaining functionality.

3. The bicycle frame of claim 2, wherein the curved surface of the touch screen computer adapts to the shape of the frame, providing compatibility with various frame geometries to accommodate different frame shapes and sizes, ensuring that the integrated system is seamlessly incorporated into a wide range of bicycle designs.

4. The bicycle frame of claim 1, wherein the touch screen computer includes all necessary characteristics of a touch screen device, including a charging port, a battery, a data port, and camera for multimedia functionalities enabling the cyclists to utilize the touch screen computer for various multimedia and communication purposes while riding.

5. The bicycle frame of claim 1, further comprising a navigation system integrated into the touch screen computer, wherein the navigation system provides map displaying and global positioning system (GPS) functions associated with the navigation tools.

6. The bicycle frame of claim 5, wherein the navigation system provides turn-by-turn directions, real-time positioning, and route customization features for the cyclists to enhance user experience, allowing cyclists to plan and navigate their rides with precision.

7. The bicycle frame of claim 1, incorporates all functions and tools associated with a cellular phone into the touch screen computer, comprising a Subscriber Identity Module (SIM) card port, cellular connectivity, messaging applications, and access to cellular network services, thereby creating a comprehensive communication and connectivity hub for cyclists.

8. The bicycle frame of claim 7, wherein the cell phone functionalities enable cyclists to make and receive calls, send and receive messages, access internet services, and stream media content while riding, enhancing convenience and connectivity for cyclists, allowing them to stay connected while on the move.

9. The bicycle frame of claim 1, wherein the integration of electronic functionalities into the frame enhances convenience, safety, and aesthetics for cyclists, by consolidating features such as navigation, multimedia, and communication into a single integrated system, enabling cyclists to experience enhanced convenience and accessibility while riding.

10. The bicycle frame of claim 1, wherein the integration of electronic functionalities into the frame enhances the cosmetic appearance of the bicycle frame with unusual shapes and displays.
